(19) United States
(12) Patent Application Publication
(10) Pub. No.: US 2023/0214700 A1
(43) Pub. Date: Jul. 6, 2023

(54) METHOD OF PERFORMING A QUANTUM COMPUTATION

(71) Applicant: SOCPRA SCIENCES ET GENIE S.E.C., Sherbrooke (CA)

(72) Inventors: Alexandre CHOQUETTE-POITEVIN, Sherbrooke (CA); Agustin DI PAOLO, Sherbrooke (CA); Alexandre BLAIS, Sherbrooke (CA)

(21) Appl. No.: 17/916,873

(22) PCT Filed: Apr. 8, 2021
(86) PCT No.: PCT/CA2021/050468

§ 371 Date: Oct. 4, 2022

Related U.S. Application Data
(60) Provisional application No. 63/007,573, filed on Apr. 9, 2020.

(51) Int. Cl. G06N 10/20; G06N 10/60

(52) U.S. Cl. CPC G06N 10/20; G06N 10/60

(57) ABSTRACT

The method can perform a quantum computation including, in sequence, initializing a plurality of qubits of a quantum processor, applying a sequence of quantum logic gates onto the qubits in accordance with a parameterized quantum circuit which is based on a problem Hamiltonian Ĥ_{problem} and at least one additional Hamiltonian Ĥk which does not commute with Ĥ_{problem,} and measuring the expectation value of Ĥ_{problem} in the final state of the qubits.

### BACKGROUND

By leveraging intrinsic properties of quantum mechanics, quantum computers may provide a disruptive computational tool for solving problems such as optimization (travelling salesman, machine learning), prime factorization, simulation of matter (materials, molecules and proteins), and financial market modeling.

The rise of increasingly powerful new quantum devices drives research to find algorithms increasingly able to leverage the computational power of small quantum processors. Hybrid quantum-classical algorithms have been introduced to this end. Known as variational quantum algorithms (VQA), such methods make use of a quantum computer only for the most performance-critical part of a program, while a more robust classical co-processor serves as an optimizer which operates in a loop with the quantum device to find the quantum circuit that transforms some state into the ground state of a given Hamiltonian.

Variational quantum algorithms leverage the use of a variational circuit, the Ansatz, that is to be executed on the quantum computer. Existing Ansatze typically aim to preserve symmetries of the problem Hamiltonian with the goal of restricting the variational search to a small subspace of the Hilbert space, and ultimately limit the expected amount of iterations to solve a problem. While existing approaches were satisfactory to a certain degree, there remained room for improvement.

### SUMMARY

It was found that using, in parameterized quantum circuits (Ansatze), Hamiltonians which break the symmetry (i.e. which does not commute with the problem Hamiltonian), could counter-intuitively lead to efficiency gains. Depending on the exact scenario, greater gains may be achievable when the symmetry-breaking Hamiltonians, while structured on the problem, allow to explore to a certain extent, but not so much as to become “lost”.

In accordance with one aspect, there is provided a method comprising performing a quantum computation including, in sequence, initializing a plurality of qubits of a quantum processor, applying a sequence of quantum logic gates onto the qubits in accordance with a parameterized quantum circuit which is based on a problem Hamiltonian Ĥ_{problem} and at least one additional Hamiltonian Ĥₖ which does not commute with Ĥ_{problem}, and measuring the expectation value of Ĥ_{problem} in the final state of the qubits.

In practice, a large number of iterations will likely be performed wherein, after each iteration, the measured expectation value is provided to a classical computer, which calculates variational parameters for the next iteration, until the process converges onto the ground state.

In accordance with another aspect, there is provided a quantum circuit in the form of computer readable instructions stored in a non-transitory memory which, when executed by a classical processor is operable to drive the application of quantum gates onto qubits of a quantum processor, wherein the quantum circuit is based on a problem Hamiltonian Ĥ_{problem} and at least one additional Hamiltonian Ĥₖ which does not commute with Ĥ_{problem}.

In accordance with another aspect, there is provided a quantum circuit in the form of computer readable instructions stored in a non-transitory memory which, when executed by a processor is operable to simulate a quantum computation, wherein the quantum circuit is based on a problem Hamiltonian Ĥ_{problem} and at least one additional Hamiltonian Ĥₖ which does not commute with Ĥ_{problem}.

In accordance with another aspect, there is provided a method comprising simulating a quantum computation including, in sequence, applying a sequence of quantum logic gates onto a plurality of qubits in accordance with a parameterized quantum circuit which is based on a problem Hamiltonian Ĥ_{problem} and at least one additional Hamiltonian Ĥₖ which does not commute with Ĥ_{problem}, and measuring the expectation value of Ĥ_{problem} in the final state of the qubits.

Many further features and combinations thereof concerning the present improvements will appear to those skilled in the art following a reading of the instant disclosure.

It will be understood that the expression “computer”, or “controller”, as used herein is not to be interpreted in a limiting manner. “computer” is rather used in a broad sense to generally refer to the combination of some form of one or more processing units and some form of memory system accessible by the processing unit(s). “controller” is used in a broad sense to generally refer to a device which performs a function of controlling, and may be a computer or another type of device. The memory system if a computer can be of the non-transitory type. The use of the expression “computer” in its singular form as used herein includes within its scope the combination of a two or more computers working collaboratively to perform a given function, independently of whether these two or more computers are local, remote, or distributed. Moreover, the expression “computer” as used herein includes within its scope the use of partial capabilities of a given processing unit.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions.

### DESCRIPTION OF THE FIGURES

In the figures,

FIG. 1A is a schematic view of a quantum system which can be implemented as a quantum processor;

FIG. 1B is a schematic view of an example of a hybrid quantum/classical computer;

FIG. 1C is a flow chart representing a hybrid quantum/classical computing process operating on the hybrid quantum/classical computer of FIG. 1B;

FIG. 2 is a schematic detailing circuit decomposition pertaining to multi-qubit gates used in the example QOCA Ansatz;

FIG. 3A is a shematic of a single layer of the VHA Ansatz, with an example QOCA Ansatz presented in FIG. 3B, and an example sQOCA Ansatz presented in FIG. 3C;

FIG. 4 plots simulation results with four different Ansatz on the 2X2 (top) and 2X3 (bottom) forms of the Fermi-Hubbard problem; and

FIG. 5 plots simulation results with four different Ansatz on the Fermi-Hubbard problem, the bottom graph shows the performance, whereas the top graph presents symmetry breaking.

FIG. 6 plots the convergence process results for the H₂O molecule with 12 qubits. The error on the energy, defined as |(E_{VQA-E₀})/E₀| where E₀ is the ground state energy, is plotted as a function of the number of optimization cycles. The dashed red line corresponds to chemical accuracy and the dashed black is the threshold on the number of optimizer steps permitted.

### DETAILED DESCRIPTION

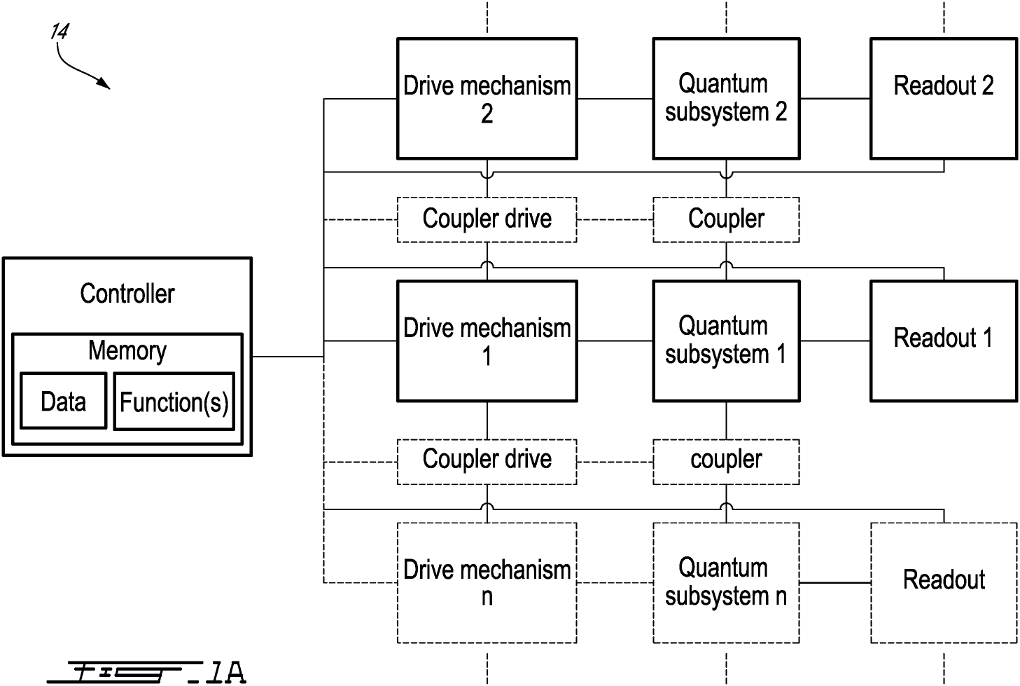

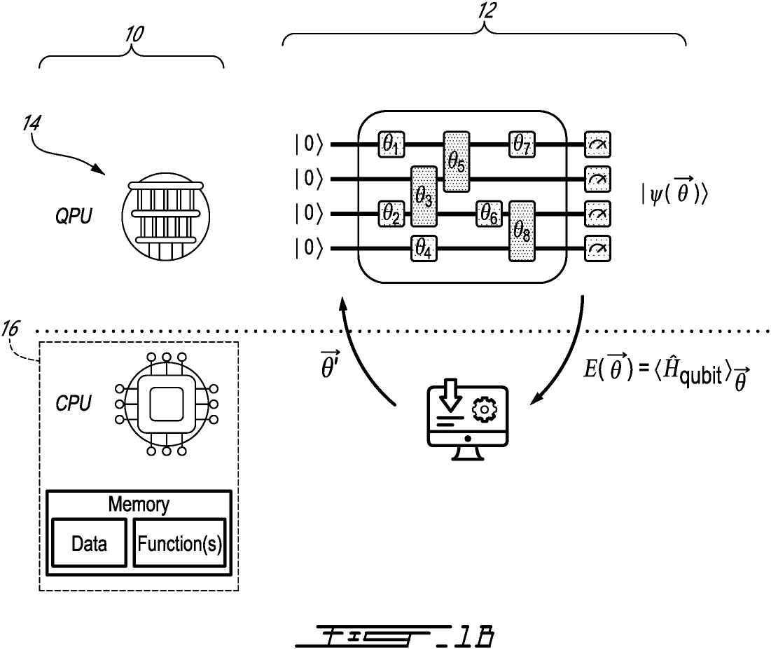

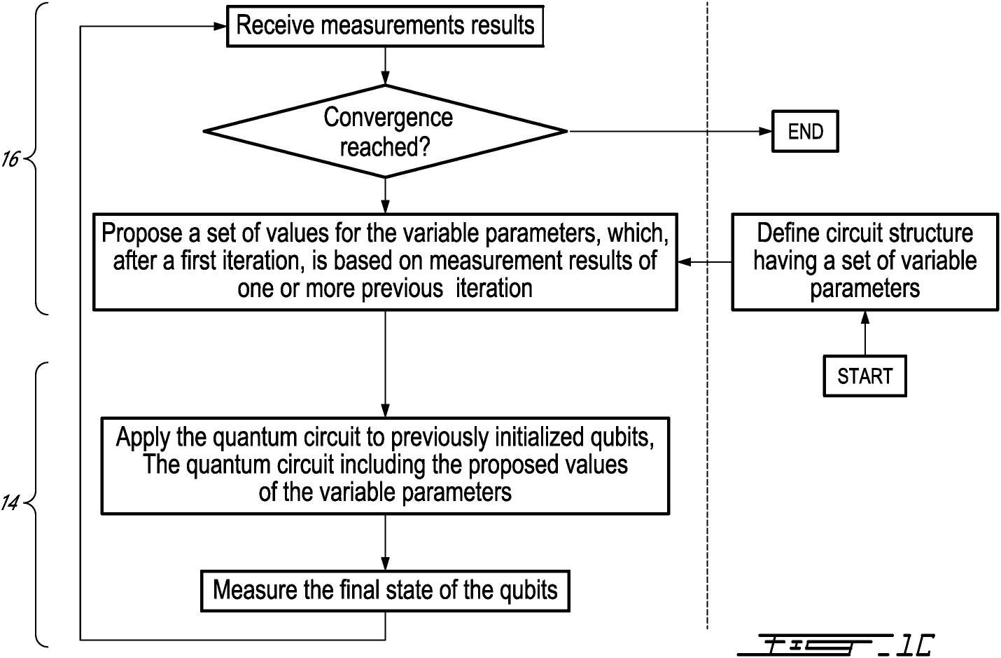

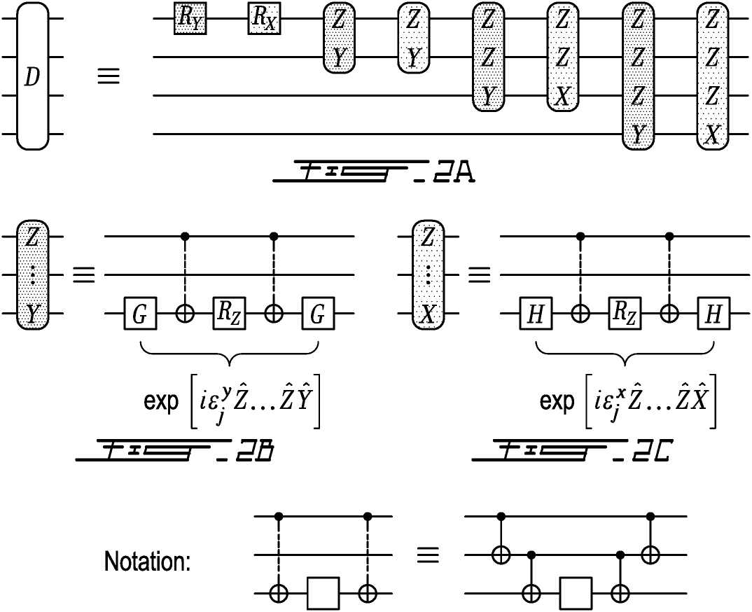

FIG. 1 presents an example of a quantum system which includes a plurality of quantum subsystems. In the context of quantum computing, the quantum subsystems are used to host logical states and can be referred to as qubits, and the quantum system can be referred to as a quantum processor 14. The nature of the qubits, the means by which logical states are hosted in the qubits, and the means by which operations are performed between the qubits depend on the choice of architecture. There are a number of competing architectures, including quantum annealers and gate-based quantum processors. However, independently of the architecture, a typical quantum processor will have at least two qubits interconnected to one another in a manner to allow them to interact in an operation which will typically involve entanglement. Most qubits embodied as bosonic-based quantum processors, for example, involve some form of resonator, and the logical states will be driven in the qubits using some form of driving hardware which can control a number of bosons in the qubits. The driving hardware is controlled by a component which will be referred to herein as a controller for simplicity, and which typically includes a classical computer. The qubits are typically refrigerated to very low temperatures and insulated from the environment. In a quantum annealing type architecture, the quantum subsystems can be directly operably interconnected to one another. In gate-based quantum computing, the quantum subsystems are typically interconnected to one another via couplers which are used to selectively control the interactions between the quantum subsystems. The couplers are also quantum subsystems operable to host states via which the logical states of the two or more connecting quantum subsystems are to interact, and are also driven by driving hardware which can be controlled by the same controller for convenience. Readout ports can be provided via which the state of the qubits can be read, an operation which can be said to involve “measuring”.

The controller can be expected to include a memory which can include functions in the form of computer readable instructions driving the operation of the controller, and data. The functions can include a “driving program”, for instance, which, in the case of gate-based quantum computing, can include a sequence of gates, typically referred to as a quantum circuit, stored as data in the memory. When the state of the qubits are read, the measured values can be stored in the form of data, for instance. As we will soon see, the data can also include variables in the form of values for parameters according to which the operations are to be performed.

FIG. 1B schematizes an example of a hybrid quantum-classical computer 10 and an associated hybrid quantum-classical algorithm 12. The hybrid quantum-classical computer 10 has a quantum computer 14 and a classical co-computer 16. As we will soon see in greater detail, the classical computer can have a computer readable memory having stored thereon functions such as an optimizer software, and data, such as values for parameters according to which operations are to be performed on the quantum computer 14. As exemplified in FIG. 1A, the quantum computer 14 has hardware associated to a number of qubits (schematized as horizontal lines in the algorithm 12) which can be referred to herein as a quantum register. The quantum computer 14 can also have hardware which allows i) to apply various quantum gates to the qubits (schematized as boxes on the lines) and ii) to measure the expectation value of the problem Hamiltonian in the final state of the qubits. As exemplified in FIG. 1A, this latter hardware can include a controller which can, depending on the embodiment, be embodied as part of the classical co-computer 16, be functionally independent from but communicatively coupled with the classical co-computer 16, or share some resources such as classical processing capabilities or computer readable memory with the classical co-computer 16.

During operation of the quantum computer 14, the sequence of quantum gates is performed in accordance with a quantum algorithm typically referred to as a quantum circuit in the art. In computing operations, a goal is to find the quantum circuit which will transform some state of qubits into the ground state of the problem. The typical process is iterative and essentially consists of making a sequence of educated guesses for the quantum circuit in a manner for the process to converge to the ground state. The quantum algorithm can be part of a classical/quantum algorithm where other processing steps are performed by the classical co-processor. In a family of approaches commonly referred to as “variational”, the quantum circuit is parameterized, meaning that the structure of the circuit (the configuration of the boxes along the lines in the upper right portion of FIG. 1B) remains constant from one iteration to the other, whereas some elements of the circuit are variable parameters Θₙ. Each quantum iteration begins by initializing the qubits (left hand side of quantum algorithm), then proceeds in applying the sequence of gates (the quantum circuit, center), and terminates by measuring the resulting state (right hand side). The resulting measured values can be stored in a memory. The classical co-processor can receive and process the measured values from the memory and using an “optimizing program”, produce, based on the measurement of the preceding quantum iteration(s), a set of parameter values which are considered suitable for the next quantum iteration within the context of the Ansatz.

An example hybrid algorithm is presented in greater detail in FIG. 1C. The hybrid algorithm can begin by receiving, or determining, a proposed circuit structure having a set of variable parameters. Based on this proposed circuit structure, the optimizing program, which runs as part of the classical computer 16, can propose a first set of values for the variable parameters. Alternately, the first set of values for the variable parameters can be separately predetermined together with the proposed circuit structure. A driving program can then operate on the quantum computer 14. The driving program will typically begin by initializing the qubits, continue with applying the sequence of gates forming the quantum circuits onto the qubits, and then terminate with the readout step in which the final state of the qubits are measured and the values can be stored in a computer readable memory. The sequence of gates is defined by the proposed circuit structure and by the first set of values for the variable parameters, in the form of data accessible to the controller. The algorithm then moves on to the optimizing program running on the classical computer which will propose a second set of values for the variable parameters considered likely to lead to convergence, and this step will take into consideration at least the measurement results received immediately previously, and typically the entire history or preceding iterations. The algorithm loops back to a second quantum computing iteration based on the second set of values, which loops back new measurement results into the optimizing software, which determines a next set of values for the variable parameters which ought to be tried out, and so forth. The optimizing program typically has a function to determine whether or not “convergence” is considered to have been reached, that to determine if it has actually been reached or is considered “close enough” to have been reached, or whether it has not yet been reached, and the optimizing program can end the algorithm when convergence has been reached. Typically, “convergence” is when the ground state is determined to have been found or satisfactorily approximated. In summary, the classical computer can run an optimizing program which proposes parameter values for successive quantum computing iterations, whereas the quantum computer can operate iterations using the sequence of proposed parameter values proposed by the optimizing program and feed the measurement results back into the optimizer program.

It will be noted here that in some alternate embodiments, instead of actually being performed on a quantum computer, the quantum computing iterations can be simulated by a quantum computing simulation program which can run on a classical computer. In this latter case, the algorithm can remain the same with the exception that the quantum computing iterations are simulated by a classical computer instead of being actually performed on quantum processing hardware.

The exact set of quantum gates allowable on a given quantum processor will vary based on the quantum processor’s build, but software solutions are available to translate (compile) a given Ansatz into terms of quantum gate elements which are available on a given quantum processor, as a function of the specific application. Some specific types of quantum processors are more efficient at running specific types of quantum circuits.

### Variational Quantum Algorithm (VQA)

More specifically, in an example scheme of Variational Quantum Algorithms (VQAs), one uses a quantum computer to prepare a quantum state |ψ(θ)〉, which is parametrized by a collection of a manageable number of classical variational parameters θ. This state is typically generated from a reference state, |ψ₀〉, to which a parametrized quantum circuit is applied to find |ψ(θ)〉 = U(θ)|ψ₀〉. This parametrized quantum circuit is often referred to as the variational Ansatz or variational form. The value of the variational parameters is then classically tuned in order to minimize the result of a cost function, which in the case of chemistry and physics problems is often the energy of the state given by the expectation value of the problem Hamiltonian

$$E \left[θ\right] = \left〈ψ \left(θ\right)\right| \hat{H} \left|ψ \left(θ\right)\right〉 .$$

VQAs thus involve four potential optimization areas:
1. finding better encoding of the problem into qubits;
2. designing an efficient parameterized quantum circuit (variational Ansâtze);
3. reducing the number of measurements in the evaluation of the cost function;
4. developing classical optimizers that are tailored to the problem and that can handle noise.

The following text concentrates on point 2, designing an efficient parameterized quantum circuit. The following questions are of interest in this task:
1. Does the parameterized quantum circuit span a subspace of the Hilbert space that comprises the target ground state?
2. If yes, does it allow for an efficient path in parameter space to travel from the initial state to the target ground state?

Because the Hilbert space is large, one may be motivated to investigate Ansâtze that preserves symmetries of the problem Hamiltonian, to constrain the system to a much smaller Hilbert space which, in principle, would increase the chances of converging to the target state in the case where it is contained in the subspace, even though it is not guaranteed that this approach allows for an efficient search through parameter space.

Counter-intuitively, it was found that introducing a symmetry-breaking component into the otherwise symmetry-preserving Variational Hamiltonian Ansatz (VHA) could allow to find shortcuts in the parameter landscape and enable convergence from a greater number of reference states. Indeed, as will be presented below, it was found that adding symmetry-breaking terms could increase the performance of VQAs in solving the Fermi-Hubbard model for 4 or more sites.

The flexibility of VQAs comes from the freedom one has for the design of the variational form U(θ), with a plethora of choices applicable to different problems.

In the following text, we will explore the Variational Hamiltonian Ansatz (VHA), but also the Quantum Control Theory Ansatz, and an Ansatz based on the combination of VHA and Quantum Control Theory, which will be referred to as Quantum Optimal Control Inspired Ansatz (QOCA), before discussing an example specific application to the Fermi-Hubbard model.

### Variational Hamiltonian Ansatz (VHA)

Ansâtze that emulate the physics of the problem can be used to favor scalability. To construct physics-inspired Ansâtze, one uses prior knowledge of the problem’s structure when designing the variational form. The Variational Hamiltonian Ansatz (VHA) is one such Ansatz, which consists of a parametrized version of the quantum circuit implementing time evolution (Trotterization) under the problem Hamiltonian. The VHA is the translation of the Quantum Approximate Optimization Algorithm (QAOA) from combinatorial optimization problems to chemistry and physics problems. In the original QAOA, the variational Ansatz is constructed by alternating the application of a diagonal cost-function based Hamiltonian with a mixing Hamiltonian (typically

$$\left({\sum }_{j} {\hat{X}}_{j}\right) .$$

This idea can be extended to include a more general class of mixing Hamiltonians. In the VHA framework, the cost-function and mixing Hamiltonians are given by the different non-commuting terms of the problem Hamiltonian Ĥ= Σⱼ Ĥⱼ. The state-preparation unitary therefore reads :

[symbol]

where θ = {θ_{j,d}} are the variational parameters. Typically, one can arrange the terms of the Hamiltonian into a manageable number of groups of commuting terms, minimizing the Trotter error. In the analogy of time evolution, the depth d is associated with each time increment of the Trotterization.

This approach can be implemented using few variational parameters, therefore easing the classical optimization, but the circuit depth, which depends on the complexity of the problem, can be very large.

Because it is built around the problem Hamiltonian, the VHA implements operations that conserve the symmetries of the problem. For example, if no term of the Hamiltonian allows the number of particles to change, this quantity will be conserved in the variational state. This restricts the variational search to a small subspace of the Hilbert space which, in the case where it comprises the target state, can increase the performance of the VQA.

### Quantum Control

Quantum control theory can be applied to the quantum control of chemical reactions, spins in nuclear magnetic resonance experiments, and to pulse shaping in superconducting qubits, to name a few examples.

To manipulate a quantum system of Hamiltonian Ĥ₀, it is coupled to one or many control apparatuses. The interactions that follow are given by a set of time-independent control Hamiltonians {Ĥₖ} which are parametrized by the time-dependent coefficients {cₖ(t)} ∈ ℝ. In general, the control Hamiltonians do not commute with Ĥ₀. The total Hamiltonian is

$$\hat{\text{H}} \left(t\right) = {\hat{\text{H}}}_{0} + {\sum }_{k} {c}_{k} \left(t\right) {\hat{\text{H}}}_{k}$$

leading to a time evolution described by

$$\text{i} \frac{\partial }{\partial \text{t}} \left|ψ \left(\text{t}\right)\right〉 = \left[{\hat{\text{H}}}_{0} + {\sum }_{\text{k}} {\text{c}}_{\text{k}} \left(\text{t}\right) {\hat{\text{H}}}_{\text{k}}\right] \left|ψ \left(\text{t}\right)\right〉 .$$

The solution to equation 4 is the unitary [symbol] , which can propagate pure states through time as [symbol] . Taking this into equation 4, the differential equation for [symbol] can be obtained:

$$i \dot{\hat{U}} \left(t\right) = \left[{\hat{H}}_{0} + {\sum }_{k} {c}_{k} \left(t\right) {\hat{H}}_{k}\right] \hat{U} \left(t\right) , \hat{U} \left(0\right) = I .$$

If the system is fully controllable, quantum control theory states that, for any initial state |ψ(0)〉, there exists a set of admissible controls {cₖ(t)} and a time T > 0 for which the time-evolved state |ψ(T)〉 is a desired target state |ψ_{target}〉. Or equivalently, that the resulting time propagator Û(T) implements a desired unitary operation Û_{ideal}.

Quantum optimal control refers to methods by which the control pulses are designed for achieving a desired state preparation. This can be realized by seeking the set of controls and time T that optimize a cost functional characterizing the state-preparation fidelity C[{cₖ(t)},T], which may include constraints such as the control time and the maximum pulse strength.

In QOC methods time can be discretized into N increments, or pixels, of duration Δt such that the total evolution is accomplished in a time T = NΔt. This discretization may correspond to the one used for the numerical integration of the Schrödinger equation if the system is simulated or to the sample rate of the control electronics in the case of an experiment. It can also be set arbitrarily.

Using this discretization, the continuous control fields cₖ(t) are parametrized by the discrete control fields uₖ as

$${c}_{k} \left(t\right) = {\sum }_{j = 0}^{N - 1} {u}_{k , j} {\prod }_{j} \left(t , Δ t\right) ,$$

where ⊓ⱼ (t,Δt) ≡ Θ(t - jΔt) - Θ(t - (j + 1)Δt) with Θ the Heaviside function. The time evolution operator for the jth pixel is

$${\hat{U}}_{j} = exp \left[- i Δ t \left({\hat{H}}_{0} + {\sum }_{k} {u}_{k , j} {\hat{H}}_{k}\right)\right]$$

and thefore the propagator for a time T is

[symbol]

Because this time propagator incorporates the symmetry-breaking terms {Ĥₖ}, it can potentially allow for quantum operations that are much faster than adiabatic evolution governed by Ĥ₀ alone, at least when the control fields are optimized. This method is thus particularly well suited to cases where the target state (or operation) is known beforehand. In such a context, these fast quantum operations are possible in view of the introduction of control, or drive, Hamiltonians {Ĥₖ} in the system.

### Quantum-Optimal-Control-Inspired Ansatz (QOCA)

Let us now considering applying the drive terms {Ĥₖ} to the VHA Ansatz to create a new Ansatz referred to as Quantum-optimal-control-inspired Ansatz (QOCA). More specifically, the VHA Ansatz, which resembles time evolution under the problem Hamiltonian Ĥ_{problem}, is modified to incorporate a set of drive terms {Ĥₖ}. This can yield a time evolution under the new Hamiltonian

$${\hat{\text{H}}}_{\text{QOCA}} \left(t\right) = {\hat{\text{H}}}_{\text{problem}} + {\sum }_{k} {c}_{k} \left(t\right) {\hat{\text{H}}}_{k}$$

The variational state preparation circuit for QOCA can now be by parametrizing the time evolution operator that follows from the procedure of the previous section as

$${\hat{U}}_{\text{QOCA}} \left(θ , δ\right) = {\prod }_{d} \left({\prod }_{j} {e}^{i {θ}_{j , d} {\hat{H}}_{j}} {\prod }_{k} {e}^{i {δ}_{k , d} {\hat{H}}_{k}}\right) .$$

Here, θ = {θ_{j,d}} and δ = {δ_{k,d}} are respectfully the VHA VHA parameters and the drive parameters. As for VHA, the d parameter is the number of layers of the Ansatz. δ_{k,d} can be used here instead of u_{k,j} to denote the discrete control fields, and thus create a notation gap between QOC and VQAs.

In principle, one has the freedom to select drive Hamiltonians that do not commute with Ĥ_{problem}, and therefore several alternate drive Hamiltonians may be used in alternate embodiments. To facilitate the identification of drive Hamiltonians which will have the most positive impact on the outcome of the VQA, search strategies such as adapt-vqe may be used.

### Specific Example Embodiments of QOCA Applied to Fermi-Hubbard Model

One of numerous possible potential implementations of QOCA is the Fermi-Hubbard model (FHM). Indeed, since FHM is considered to be notoriously hard to solve using classical computers, it can make a good candidate for a proof of principle experiment, and it is thus believed that achieving performance with FHM is a good indication that adaptations of the Ansatz would perform on other problems. Indeed, FHM offers one of the simplest ways to investigate systems with strong interactions between fermions (strongly-correlated systems). Despite its apparent simplicity, it can give rise to metallic, insulating, magnetic, and even superconducting phases of matter which motivated its study to understand systems ranging from heavy fermions to high-temperature superconductors.

A particularly interesting instance of the FHM is the so-called half-filling regime at intermediate coupling. In this regime, even some of the biggest classical supercomputers have failed to solve the FHM for more than 20 lattice sites.

In terms of fermionic ladder operators [symbol] , the FHM Hamiltonian for L lattice sites is given by

[symbol]

where i,j are the lattice site indices and σ={↑,↓} is the spin index. (i,j) denotes a sum over nearest-neighbor sites and [symbol] is the occupation operator of spin-orbital iσ. The first term of eq. 11 represents the nearest-neighbor hopping of amplitude t and will often be denoted T. The second term is the on-site Coulomb repulsion of strength U, and the last term is the chemical potential. We often use [symbol] to denote the last two terms. The value of µ sets the filling of the ground state, with µ=U/2 ensuring half-filling. Because the Pauli exclusion principle only allows for occupations of up to two fermions per lattice site, half-filling occurs when there is on average one electron per site,

$$E \left[\left〈{\hat{n}}_{i ↑} + {\hat{n}}_{i ↓}\right〉\right] = 1.$$

Here, a Hybrid quantum-classical methods is used as a way to investigate the thermodynamical properties of the FHM. The challenge associated to preparing the ground state of the model on a quantum processor is tackled by a VQA.

More specifically, the Jordan-Wigner (JW) transformation can be used to encode the FHM into a qubit Hamiltonian. In the JW framework, each fermionic site is encoded into the state of two qubits as (0, ↑, ↓, ↑↓) ↦ (00,01,10,11) and the fermionic ladder operators are given by [symbol] where and the greek subscripts denote the spin-orbital indices as v=jo. For a system of L sites, the N=2L spin-orbitals are arranged as [symbol] but the choice is purely conventional.

Hopping terms between spin-orbitals v and µ with v<µ transforms as [symbol] where the product of ^{%}operators, referred to as the JW string, vanishes when µ=v+1. The number operator on orbital v and therefore the onsite Coulomb interaction between orbitals v and µ become, using the convention

[symbol]

At half-filling, i.e. setting µ=U/2 in eq. 11, the single [symbol] coming from the onsite interaction terms are cancelled by the chemical potential, leaving a simpler Hamiltonian composed solely of X.X·Y.Y (plus JW strings when fermionic orbitals are not adjacent) and ZZ qubit interactions.

### Discussion Pertaining to Potential Implementations

The performance of VQAs strongly depends on the choice of initial state and variational parameters. The initial state acts as an educated guess to the target state and is often one that is easily computed classically. However, its preparation on a quantum computer is generally not an easy task and may require a large overhead in terms of circuit depth.

To compare all Ansâtze on the same footing, we first used the equal superposition of all basis states as initial state. It is prepared by simply applying Hadamard gates on all qubits [symbol] . One advantage of this state is that it is easy to prepare. Also, for simulation done at half-filling, this state already has the desired number of particles and total spin since it is akin to placing half a fermion on every fermionic orbital.

This choice of initial state allows for demonstration of the robustness of the Ansâtze to unstructured initial conditions. The performance can be increased at the expense of deeper circuits by using the ground state of the non-interacting FHM i.e. fixing U = µ = 0 in eq 13, as initial state.

In the application of drive terms to a VHA, as opposed to QOC, the drive terms do not need to describe actual physical interactions present in a control hardware, providing for more freedom to engineer desired interactions.

In a first step, the drive was adapted from QOC experiments where control is done through RF voltage pulses. In this case, the X and Y quadratures of the electromagnetic field are driven generating the interaction Hamiltonians [symbol] where [symbol] and [symbol] are bosonic operators.

Expressing these terms by means of fermionic operators and applying a drive on every lattice site, the following interaction Hamiltonians are achieved: [symbol] [symbol] where are now fermionic operators. This formulation no longer describes the X and Y quadratures of a bosonic field but rather describes a coupling of each lattice site to a bath of Majorana fermions [symbol] and [symbol] .

The drive equations for a spinless system can be derived, and the resulting circuit can be applied to both species of spins. Doing the JW transformations of eq. 12 on equations 15 and 16 et find:

[symbol]

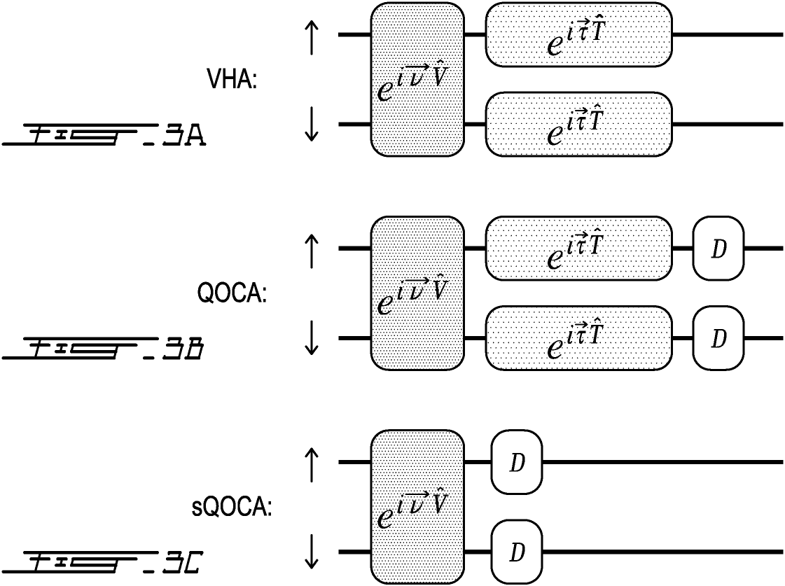

To incorporate equations 17 and 18 into the QOCA variational form of equation 10, the drive terms are exponentiated. By performing a first-order Trotter-Suzuki decomposition, we obtain the drive circuit equation for one layer of the Ansatz, [symbol] where {δ_{k,d}} are the variational parameters associated with each drive term. Note that we intertwined the application of Ĥ₁ and Ĥ₂ to better emulate a simultaneous drive of all sites. A schematic of the circuit implementing equation 19 for four qubits is illustrated in FIG. 2 . While, the optimal way to decompose this circuit into basis gates depends on the quantum hardware on which it will executed, a standard compilation into CNOTs is shown. In this case, the circuit depth can be drastically shortened.

More specifically, FIG. 2A shows circuit decomposition of the drive used for QOCA. This circuit generalizes to any number of qubits by appending more Ẑ ...ẐŶ and Ẑ ... ẐX̂ subcircuits at the end. FIGS. 2B and 2C are a decomposition of these multi-qubit gates based on a conventional approach to decompose exponentials of Pauli strings into circuits of CNOTs. The transformation

$$H = \left(\hat{X} + \hat{Z}\right) / \sqrt{2}$$

is the Hadamard gate which changes between the X̂ and Ẑ bases and

$$G = \left(\hat{Y} + \hat{Z}\right) / \sqrt{2}$$

is the equivalent transformation between the Ŷ and Ẑ bases. The angles of the Rₐ(θ) = exp[-iθâtσₐ/2] rotations are the variational parameters, where âtσₐ is a Pauli matrix.

The circuit designer also has the freedom to decide where to incorporate the variational parameters within the Ansatze. It is possible to interpolate between two parametrization strategies to achieve this, for instance. In the first one of these strategies, the Ansatz is fully parametrized and the second one presents a number of parameters that is independent of the number of qubits used for the computation. It will be noted that in various embodiments, various variational parameter incorporation strategies can be used, such as focussing on only the first one, focussing only on the second one, using a different variational parameter incorporation strategy and interpolating between any two variational parameter incorporation strategies, to name some possible examples.

The first strategy corresponds to defining all (or almost all) gate angles as variational parameters. This can give the classical optimizer a lot of freedom to explore the Hilbert space spanned by the Ansatz, but comes at the cost of longer optimization time. Moreover, this strategy might not be suitable for larger instances of problems which could require an larger number of parameters.

Using this strategy for VHA can consist of assigning one parameter to every âd_{iσ}â_{jσ} + h. c. hopping terms and duplicating the parameter for both flavors of spins. This is because at half-filling and zero total spin, there is a spin-inversion symmetry which removes the need to treat spins up and down differently. Additionally, every term of the on-site interaction is associated with a variational parameter.

QOCA can be implemented similar to VHA, to which we add the drive terms where all

$${δ}_{j}^{x}$$

and

$${δ}_{j}^{y}$$

become variational parameter in equation 19. The fully parameterized version of QOCA will be referred to as QOCAf hereinbelow.

In the second strategy, scalable parametrization, we employ a number of variational parameters that is independent of the system size. Because there are fewer parameters, we expect the optimization to be faster, but larger circuit depths might be necessary to achieve the same accuracy a full parametrization of the Ansatz would provide.

In physics-inspired Ansatze, a scalable parametrization can be performed by collecting terms of the Hamiltonian into a constant number of groups and affiliating a single parameter to each group. For example, a common way of grouping the terms of the 2D FHM is

$${\hat{H}}_{F H M} = {\hat{H}}_{h , \text{even}} + {\hat{H}}_{h , \text{odd}} + {\hat{H}}_{v , \text{even}} + {\hat{H}}_{v , \text{odd}} + {\hat{H}}_{U} ,$$

where the first four Hamiltonians group the even and odd, vertical and horizontal hopping terms and Ĥ_{U} collects the on-site interaction terms. Note that for the 3D FHM, two additional groups of hopping terms covering the third dimension may be necessary. This partitioning can be chosen in order to minimize the Trotter error when implementing the Ansatze since every term within each group commute with all the others.

The scalable parametrization version of QOCA will be referred to as QOCAs hereinbelow.

One drawback of QOCA as presented above is that the drive circuits can be deep depending on the nature of the drive. It can be preferred to shorten the total Ansatz circuit without compromising the effect of the drive and therefore the overall performance.

Because we apply the drive D of FIG. 2 independently on spins up and down, it generates entanglement only among spins of the same flavor. However, the kinetic part of eq. 11, which does not couple the spins, also entangles the same qubits.

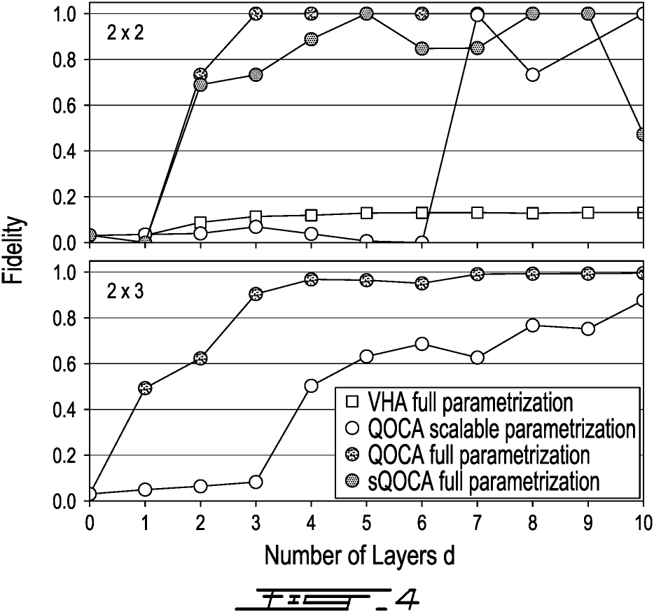

In at least some embodiments, the kinetic part of the VHA can be removed with an acceptable tradeoff in performance. The kinetic part is more costly in circuit depth than the interaction part, which can lead to efficiencies. The result will be referred to as short QOCA (sQOCA) Ansatz. It can be expressed as

$${\hat{U}}_{s Q O C A} \left(v , δ\right) = \prod {}_{d} \left(\prod {}_{j} {e}^{i {v}_{j , d} {\hat{V}}_{j}} \prod {}_{k} {e}^{i {δ}_{k , d} {\hat{H}}_{k}}\right) ,$$

where V̂ is the on-site interaction part of eq. 11 and v = {v_{j,d}} are the associated variational parameters. sQOCA is presented schematically at FIG. 3C, and compared to the schematics of QOCA (FIG. 2C) and VHA (FIG. 2A). It will be noted that sQOCA is also achievable in the fully or scalable parametrization versions, e.g. sQOCAf and sQOCAs.

More specifically, FIG. 3 presents schematics of a single layer of Ansatze. FIG. 3A shows the variational Hamiltonian Ansatz (VHA) equation 2, FIG. 3B shows the quantum-optimal-control-inspired Ansatz (QOCA) equation 10 and FIG. 3C shows the shallower version of QOCA, the short QOCA Ansatz (sQOCA) equation 21. The circuit lines represent qubit registers encoding the spin orbitals associated with the ↑ or ↓ spins. For HEA, the entangling block is a ladder of CNOT similar to the ones in the Notation box of FIG. 2. For all other Ansatze, T̂ and V̂ are respectively the kinetic and interaction parts of the problem Hamiltonian and {τ,v} are their associated variational parameters. The drive D is defined in equation 19 and illustrated on FIG. 2.

Numerical simulations were conducted using the VQA tools provided by Qiskit Aqua™. A unitary statevector simulator was used since no noise was considered and we assume an all-to-all coupling graph. The COBYLA method was used as the classical optimizer with a maximum number of function evaluation of ~ 10⁵. This number can be justified using experimentally realistic arguments.

So far, our discussion of variational Ansatze remains hardware-agnostic in the sense that any digital quantum computer can be used for our purpose. The list of available technology includes: superconducting qubits, trapped ions, spin qubits, photonic qubits, Rydberg atoms, among others. Each one of these architectures operates differently and allow for different quantum operations to be executed natively on the hardware. Moreover, different approaches within a particular technology might also lead to different quantum operations.

Before executing a quantum circuit on a real quantum computer, it must be compiled into native gates, that is the set of quantum logical gates the hardware is calibrated to perform. This native gates set is typically composed of arbitrary single-qubit rotations and a two-qubit interaction. Furthermore, the compilation should take into account the qubit connectivity layout of the quantum computer. Because of these constraints, a particular architecture might be more suitable than others to run a quantum circuit.

For example, Google’s approach to superconducting qubits seems suitable for fermionic problems. In particular, their choice of two-qubit gate, the so-called fermionic simulation gate

$$\text{fSim} \left(θ , ϕ\right) = \left(\begin{matrix}1 & 0 & 0 & 0 \\ 0 & cos θ & - i sin θ & 0 \\ 0 & - i sin θ & cos θ & 0 \\ 0 & 0 & 0 & {e}^{- i ϕ}\end{matrix}\right) ,$$

can natively perform parametrized X̂X̂+ ŶŶ and ẐẐ interactions, which are common in fermionic problems since they are particle conserving. Other architectures might have advantages for other quantum or classical problems.

A quick sidenote will be made here that quantum computers are typically noisy, but the nature of the noise depends strongly on the exact nature of the hardware of the quantum computer on which the quantum circuit will ultimately be run. Accordingly, in the simulations which were conducted, noise was not simulated. It is believed that simulation of noise may be preferably conducted at a later time, in view of establishing whether, say, a specific build of quantum computer is well adapted to run a specific quantum circuit, for instance.

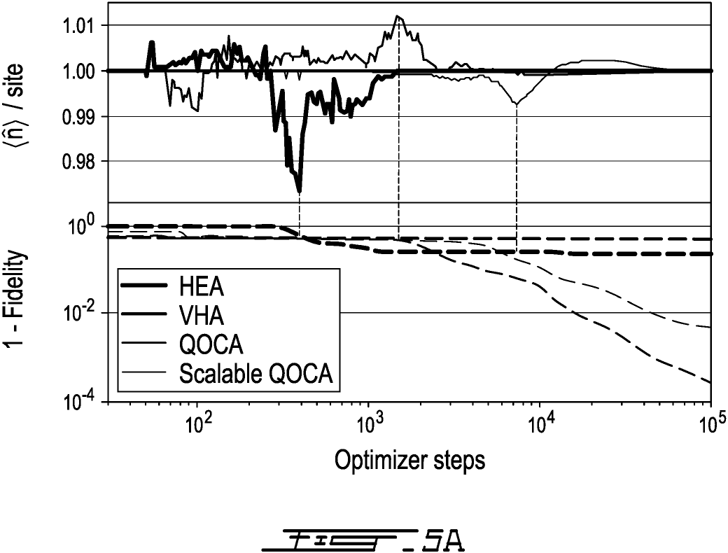

The results of simulations using VHA, QOCAs, QOCAf, and sQOCAf are presented in FIG. 4. More specifically, final variational state fidelities F = |〈ψ(θ)|Ω〉|², where |Ω〉 is the ground state of the Fermi-Hubbard model, as a function of the number of layers d of the variational Ansatz used. Top panel is for a 2 × 2 plaquette while the bottom panel is for 2 × 3 without periodic boundary conditions. For all simulations, the initial state is the equal superposition of all basis states H^{⊗n}|0〉.

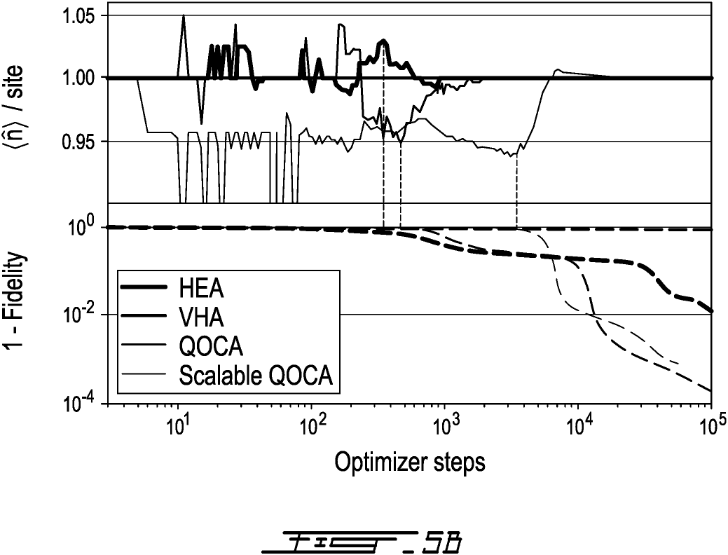

The results of the simulations using VHA, full parametrization QOCA (QOCAf), Scalable parametrization QOCA (QOCAs), and another, fully parametrizable, Ansatz HEA, are presented in FIG. 5A. The lower graph of FIG. 5A plots performance as a reduction in 1-Fidelety over optimizer steps. One can see that scalable QOCA and fully parameterized QOCA generate good results, whereas VHA and HEA do not. The upper graph of FIG. 5A represents departures from symmetry conservation, with perfect symmetry conservation being illustrated as 1.00.

FIG. 5B is similar to the FIG. 5A, but presents results obtained with different initial parameters. The top graph shows average number of particles per lattice site in the variational state at every iteration (optimizer steps) of the VQA routine. At half-filling this quantity should be equal to 1. The bottom graph shows corresponding variational state infidelity 1 - |〈ψ(θ)|Ω〉|² with the ground state of the Fermi-Hubbard model |Ω〉. The results are for a 2 × 2 system and the initial state is H^{⊗n}|0〉^{⊗n} for all Ansatze. Ansatz depth d = 9 were p used for HEA and d = 10 for the others.

All variational parameters can be initialized to 0 at every opportunity, so that Hamiltonian-based Ansatze implement the identity operator at first. This choice can be made to ensure that the variational search truly starts from the unaltered initial state. In some cases, however, this strategy resulted in premature convergence of the optimizer into states close to the initial guess, which could be circumvented by using a random initialization of the parameters. Finally, all layers of the Ansatze where optimized simultaneously. In alternate embodiments, improvement may be achievable by adopting a layer-by-layer optimization strategy.

It is interesting to see in FIGS. 5A and 5B that peaks in departure from symmetry conservation seem to roughly coincide with sudden increases in performance, and this is true not only for QOCA, but also for HEA, even though with HEA, the increase in performance is limited and fans out. These results suggest that controlled symmetry breaking, such as via the use of appropriate drive terms may be an important key to improving the efficiency of VQA’s more generally.

### Generalization of Fermionic Hamiltonians

Variational quantum algorithms are based on heuristics. Variational forms can be built using some physical intuition, but theory may not allow to go so far as to explain why a particular construction might or might not work. A first reasonable approach would be to build a variational Ansatz only using terms that preserve symmetries of the problem Hamiltonian H_{problem}. This way, we ensure that the variational landscape is completely structured with respect to H_{problem} in the sense that every possible variational state, corresponding to every point in this variational landscape, will conserve symmetries of H_{problem}. This approach is typically good as it prevents the VQA from searching an exponentially large Hilbert space. Indeed, the search is restricted only the small sub-space of the full Hilbert space corresponding to the symmetry sectors of H_{problem}.

However, allowing some symmetries to be broken can lead to faster convergence to the target state or unitary operation. One way to achieve this is by controlling the system using drive terms that do not commute with the system’s Hamiltonian. This allows for a richer set of states to be reached, which often leads to faster quantum operations. In the case where the control is operated through laser pulses, these drive terms typically take the form (b̂^{†} + b̂) and i(b̂^{†} - b̂), where b̂^{†} and b̂ are the bosonic creation and annihilation operators of the controlled system.

As a first attempt to build drive terms for fermionic systems, we textually translated these bosonic drives into fermionic operators to obtain

$${\hat{H}}_{1} = \sum {}_{J = 1}^{L} \left({\hat{a}}_{j}^{†} + {\hat{a}}_{j}\right) ;$$

$${\hat{H}}_{2} = \sum {}_{J = 1}^{L} i \left({\hat{a}}_{j}^{†} + {\hat{a}}_{j}\right) ,$$

where

$${\hat{a}}_{j}^{†}$$

and âⱼ are now fermionic ladder operatorsoperators respecting the anti-commutation relations

$$\left\{{\hat{a}}_{i} , {\hat{a}}_{j}^{†}\right\} = {δ}_{i j}$$

and

$$\left\{{\hat{a}}_{i} , {\hat{a}}_{j}\right\} = \left\{{\hat{a}}_{i}^{†} , {\hat{a}}_{j}^{†}\right\} = 0.$$

Intuitively, one can expect these linear terms to perform well since they do not commute with any physical fermionic Hamiltonian, which are composed of quadratic and quartic fermionic terms only. Indeed, these latter equations do not conserve neither the number of particles nor the parity symmetries. Moreover, when transformed to a qubit form via the Jordan-Wigner transformation,

$${\hat{H}}_{1} ↦ \sum {}_{j = 1}^{L} {\hat{X}}_{j} {⊗}_{l < j} {\hat{Z}}_{l} ,$$

$${\hat{H}}_{2} ↦ \sum {}_{j = 1}^{L} {\hat{Y}}_{j} {⊗}_{l < j} {\hat{Z}}_{l} ,$$

we remark that these drive terms decompose into a series of multi-qubit interactions which produce entanglement amongst the qubits. This is desired since the target state is likely to be highly entangled. As it will be explained later, this choice of drive terms produced promising results for the Fermi-Hubbard model and the water molecule, two hard problems of condensed matter physics and quantum chemistry respectively.

In what follows, we first formalize why non-commuting terms can help produce a richer set of states and then give some intuition as to why the selected drive terms of equations 23 and 24 are a good choice for fermionic problems.

To know if adding a non-commuting drive term to the Hamiltonian help reaching more states, we must first know what states can be reached without the addition of the drive term. For this purpose, we are interested in the notion of controllability of a given system Ĥ₀ + Σₖ cₖ(t)Ĥₖ.

We start by writing the Schrödinger equation of the control problem described above

$$\hat{U} \left(t\right) = - i \left[{\hat{H}}_{0} + \sum {}_{K} {c}_{k} \left(t\right) {\hat{H}}_{k}\right] \hat{U} \left(t\right) , \hat{U} \left(0\right) = I .$$

The solution of which is the unitary Û(t), which can propagate pure states through time as |ψ(t)〉 = Û(t)|ψ(0)〉.

The system Ĥ₀ + Σₖ cₖ(t)Ĥₖ is said to be controllable is the set of possible matrices that can be obtained from solving equation 27 is the set of all the unitary matrices. Let us begin by detailing what a reachable set is.

The reachable set at time T > 0 for system of equation 27, ℜ(T), is the set of all unitary matrices U̅ such that there exists {cₖ} ∈ C̅ with Û̅(T,{cₖ}) = U̅. Here, we take C̅ to be the set of piecewise constant functions as it is justified by the Trotterization of equation 8. Then, the reachable set at any time is defined as

$$R = {U}_{T \geq 0} R \left(T\right) .$$

This relates to the system through a theorem which states that the set of reachable states for system Ĥ₀ + Σₖ cₖ(t)Ĥₖ is the connected Lie group associated with the Lie algebra L generated by span_{_{{ck}}∈c̅}{-iĤ₀,-iĤₖ}. In short,

$$R = {e}^{L} ,$$

where the Lie group e^{L} is defined as

$${e}^{L} ≡ \left\{{e}^{{A}_{1}} {e}^{{A}_{2}} … {e}^{{A}_{m}} , {A}_{1} {A}_{2} , … , {A}_{m} ∈ L\right\}$$

The system is controllable if dim(L) = n² = dim(u(n)), where n is the size of the Hilbert space and u(n) is the Lie algebra of skew-Hermitian n × n matrices. This is equivalent to L = u(n) or e^{L} = U(n), where U(n) is the Lie group of unitary matrices of dimension n. The system is also said to be controllable when dim(L) = n² - 1 = dim(su(n)), where su(n) is the Lie algebra of matrices of u(n) with zero trace, or equivalently when L = su(n) or e^{L} = SU(n), where SU(n) is the set of matrices of U(n) with determinant equal to one.

The dynamical Lie algebra of the system L can be generated iteratively by taking all (possibly repeated) commutators of elements of L and appending L when a new matrix is found. In other words, dim(L), therefore the set of reachable states ℜ, increases for every non-commuting control Hamiltonian Ĥₖ that is added to the set and generates a new term.

This shows that adding drive terms {Hₖ} that don’t commute with Ĥ_{problem} in the QOCA variational form (equation 10) can increase the set of reachable variational states and therefore can possibly lead to shortcuts in the parameter landscape.

In the QOCA variational form, the goal is to add drive terms that could expand the set of reachable states. A good starting point would be to sample these terms from a fully controllable fermionic Hamiltonian since we know from the theorem that the set of reachable states is given by the span of its terms. The fermionic Hamiltonian

$$\begin{matrix}{\hat{H}}_{f} \left(t\right) = \sum {}_{j} \left({a}_{j} \left(t\right) {\hat{a}}_{j} + {a}_{j}^{*} \left(t\right) {\hat{a}}_{j}^{†}\right) + \sum {}_{i , j} {β}_{i j} \left(t\right) \left({\hat{a}}_{i}^{†} {\hat{a}}_{j} + {\hat{a}}_{i}^{†} {\hat{a}}_{i}\right) + \\ \sum {}_{i , j} {γ}_{i j} \left(t\right) {\hat{a}}_{i}^{†} {\hat{a}}_{i} {\hat{a}}_{j}^{†} {\hat{a}}_{j}\end{matrix}$$

is universal in the sense that any unitary matrix can be generated by solving its Schrödinger equation as in equation 27. This control Hamiltonian (eq. 30) is unphysical since it contains linear terms that break the parity symmetry, which is not allowed for physical Hamiltonians. Indeed, physical Hamiltonians must only contain terms that are at least quadratic in fermionic operators and are an even power thereof. For example, the Fermi-Hubbard model only contains quadratic â^{†}â and quartic â^{†}ââ^{†}â terms which are captured by the last two sums of eq. 30.

Because physical Hamiltonians never contain linear terms, using drives of the form of α(t)â + a^{∗}(t)â^{†} guaranties that they will not commute with Ĥ_{problem} and therefore expanding the set of reachable states.

In the context of VQAs, one could build the most general fermionic variational form by performing a Trotterization of the time evolution operator when the control functions α, β, γ are constant piecewise functions. The variational circuit therefore reads

$$\begin{matrix}{\hat{U}}_{f} \left(α , β , γ\right) = \\ {\prod }_{d} \left({\prod }_{j} {e}^{i \left({α}_{j , d} {\hat{a}}_{j} + {α}_{j , d}^{∗} {\hat{a}}_{j}^{†}\right)} {{\prod }_{i j} e}^{i {β}_{i , j , d} \left({\hat{a}}_{i}^{†} {\hat{a}}_{j} + {\hat{a}}_{j}^{†} {\hat{a}}_{i}\right)} {{\prod }_{i j} e}^{i {γ}_{i , j , d} {\hat{a}}_{i}^{†} {\hat{a}}_{i} {\hat{a}}_{j}^{†} {\hat{a}}_{j}}\right) ,\end{matrix}$$

where α = {α_{j,d}}, β = {β_{i,j,d}} and γ = {γ_{i,j,d}} are the variational parameters. Because this is a Trotterization, the universality is guaranteed only in the limit of large d. The variational form can be seen as a more general version of QOCA (eq 10).

Although the Ansatz of quation 31 is appealing because of its universality, it will lead to very long quantum circuits and is completely unstructured with respect to Ĥ_{problem}. To this end, with the QOCA variational form, we propose to only keep the quadratic and quartic terms of equation 30 that are also present in Ĥ_{problem} alongside the linear drive terms. This way, the variational landscape is structured around the symmetries of Ĥ_{problem} and the drive terms allow for exploration outside of that sub-space of the Hilbert space.

### Selection of an Additional Symmetry-Breaking Hamiltonian

If some insights are known about which symmetries are broken in the target state, one can use this information to construct drive terms that are tailored to the problem. For example, if we know that we are looking for a state that has an antiferromagnetic order and no term of describes such an order, we can think of adding a drive that has the shape of an alternating magnetic field

$$\hat{M} = h {\sum }_{j} {\left(- 1\right)}^{j} {\hat{S}}_{j}^{z} ,$$

where

$${\hat{S}}_{j}^{z} = {\hat{a}}_{j , ↑}^{†} {\hat{a}}_{j , ↑} - {\hat{a}}_{j , ↓}^{†} {\hat{a}}_{j , ↓}$$

is the total spin of site j and h is the strength of the magnetic field. Moreover, if one wishes to enforce singlet superconductivity, a drive of the form

$${\sum }_{i , j} {\hat{a}}_{i , ↑} {\hat{a}}_{j , ↓} + {\hat{a}}_{j , ↑} {\hat{a}}_{i , ↓} + \text{h} \text{.c} \text{.,}$$

or more generally,

$${\sum }_{i , j} {\hat{a}}_{i} {\hat{a}}_{j} + {\hat{a}}_{j}^{†} {\hat{a}}_{i}^{†} ,$$

might be useful since they create and annihilate Cooper pairs.

A non-exhaustive list of potential drive terms is presented in table 1, below, for the case of bosonic and fermionic systems. Note that not all drive terms are physical interactions.

TABLE 1

Potential drive Hamiltonians for bosonic and fermionic systems
Bosons

| | |
|---|---|
| Linear bosonic drive | ${\sum }_{j} \left({α}_{j} \left(t\right) {\hat{b}}_{j} + {α}_{j}^{∗} \left(t\right) {\hat{b}}_{j}^{†}\right)$ |
| Self-Kerr interaction | ${\sum }_{i} {K}_{i} \left(t\right) {\hat{b}}_{i}^{†} {\hat{b}}_{i}^{†} {\hat{b}}_{i} {\hat{b}}_{i}$ |
| Cross-Kerr interaction | ${\sum }_{i \neq j} {K}_{i j} \left(t\right) {\hat{b}}_{i}^{†} {\hat{b}}_{i} {\hat{b}}_{j}^{†} {\hat{b}}_{j}$ |
| Beam-splitter interaction | ${\sum }_{i , j} {β}_{i j} \left(t\right) \left({\hat{b}}_{i}^{†} {\hat{b}}_{j} + {\hat{b}}_{j}^{†} {\hat{b}}_{i}\right)$ |
| Single-mode squeezing | ${\sum }_{i} \left({ζ}_{i} \left(t\right) {\hat{b}}_{i}^{2} + {ζ}_{i}^{∗} \left(t\right) {\hat{b}}_{i}^{† 2}\right)$ |
| Two-mode squeezing | ${\sum }_{i \neq j} \left({ζ}_{i j} \left(t\right) {\hat{b}}_{i} {\hat{b}}_{j} + {ζ}_{i j}^{∗} \left(t\right) {\hat{b}}_{i}^{†} {\hat{b}}_{j}^{†}\right)$ |
| Linear fermionic drive | ${\sum }_{j} \left({α}_{j} \left(t\right) {\hat{a}}_{j} + {α}_{j}^{∗} \left(t\right) {\hat{a}}_{j}^{†}\right)$ |
| Alternating magnetic field | $h {\sum }_{j} {\left(- 1\right)}^{j} {\hat{S}}_{j}^{z}$ |
| | ${\hat{S}}_{j}^{z} = {\hat{a}}_{j , ↑}^{†} {\hat{a}}_{j , ↑} - {\hat{a}}_{j , ↓}^{†} {\hat{a}}_{j , ↓}$ |
| Nearest-neighbor Coulomb interactions | ${\sum }_{\left〈i , j\right〉 , σ} {\hat{η}}_{i , σ} {\hat{η}}_{j , σ}$ |
| | ${\sum }_{\left〈i , j\right〉} \left({\hat{η}}_{i , ↑} {\hat{η}}_{j , ↓} + {\hat{η}}_{i , ↓} {\hat{η}}_{j , ↑}\right)$ |
| | ${\hat{η}}_{i , σ} = {\hat{a}}_{i , σ}^{†} {\hat{a}}_{i , σ}$ |
| Nearest-neighbor singlet-pairing correlations (superexchange) | $- J {\sum }_{\left〈i , j\right〉} {\hat{c}}_{i j}^{†} {\hat{c}}_{i j}$ |
| | ${\hat{c}}_{i j}^{†} = \frac{1}{\sqrt{2}} \left({\hat{a}}_{i ↑}^{†} {\hat{a}}_{j ↓}^{†} - {\hat{a}}_{i ↓}^{†} {\hat{a}}_{j ↑}^{†}\right)$ |
| Pair hopping | $- α J {\sum }_{\left〈i j k\right〉}^{i \neq k} \left({\hat{c}}_{i j}^{†} {\hat{c}}_{j k} + {\hat{c}}_{j k}^{†} {\hat{c}}_{i j}\right)$ |
| General cubic interaction | ${\sum }_{i j k} \left(α \left(t\right) {\hat{a}}_{i}^{†} {\hat{a}}_{j} {\hat{a}}_{k} + β \left(t\right) {\hat{a}}_{i} {\hat{a}}_{j}^{†} {\hat{a}}_{k} + γ \left(t\right) {\hat{a}}_{i} {\hat{a}}_{j} {\hat{a}}_{k}^{†} + h . c .\right)$ |

### Generalization to Other Types of Problems

The QOCA method was tested on the Fermi-Hubbard model (ref eq 13 above) with the drive terms 1 and 2. The VHA method was applied on the same problems. To put all Ansatze on an equal footing and to test their robustness to simple initial states, we initialize the circuit in the equal superposition of all basis states |ψ₀〉 = H^{⊗N}|0〉^{⊗N}, which is easy to prepare.

To quantify the quality of the variational state |⊗(θ)〉 that is produced, we calculate its fidelity with the target state |Ω〉, which is the ground state of the FHM. We define the fidelity cost-function as

$$F = {\left|\left〈ψ \left(θ\right) \left|Ω\right)\right〉\right|}^{2} .$$

FIG. 4 shows F as a function of the number of layers d of the Ansatze for a 2 x 2 and a 2 × 3 plaquettes without periodic boundary conditions. Results for the 2 × 2 system show that both parametrizations of QOCA clearly outperform VHA in finding the target state. The success of QOCA still holds for the 2 × 3 system.

FIG. 5B, for instance, shows that breaking symmetries of Ĥ_{problem} can lead to better performance. We plot the evolution of two quantities throughout the optimization process: on the top is the average number of particles per lattice site and on the bottom is the infidelity 1 – F of the variational state with respect to the the target state. These simulations were done at half-filling, which means that the average number of particles per lattice site should be equal to one in the ground state. Moreover, the initial state |ψ₀〉 = H^{⊗N}|0〉^{⊗N} already has the correct number of particles and total spin zero.

The number of particles is always constant for VHA since this Ansatz does not allow this quantity to change. This Ansatz presents bad performance, which can be seen from the infidelity remaining high until the maximum number of iteration is reached.

For QOCA with the full and scalable parametrizations, we observe that the number of particles deviates from one as it is enabled by the drive terms which are particles non-conserving. The interesting fact is that peaks in the number of particles are often associated with the triggering of abrupt descents in the infidelity plot.

To corroborate this fact we also present results obtained with the hardware-efficient Ansatz, another Ansatz that does not preserve symmetries of Ĥ_{problem}. These results also show peaks in particle number associated with drops of infidelity.

These results give insight that allowing the breaking of symmetries, such as the number of particles, helps the classical optimizer to find regions of steep gradients that are otherwise impossible to reach. This leads to faster convergence to the target state.

FIG. 5A is similar to FIG. 5B but with an initial state that is one of the degenerated ground states of the non-interacting FHM with an overlap of F ≃ 0.42 with the target state. The discussion also applies here as the peaks are even more visible.

As a very preliminary test of QOCA for quantum chemistry problems, we tackled the H ₂O molecule with 12 qubits. The Ansatz used was one based on the Hamiltonian of a periodic 1 × 6 Fermi-Hubbard chain with the drive terms 1 and 2 above. A full parametrization strategy us used and the initial state is the easily prepared Hartree-Fock approximation to the ground state.

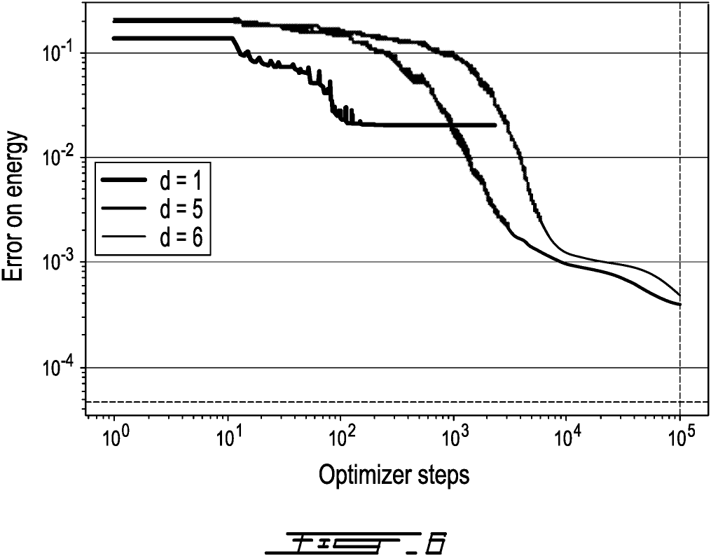

Convergence process results for the H ₂O molecule are presented in FIG. 6 for d = 1,5,6 Ansatz layers. Although chemical accuracy is not reached, we notice that the energy has not plateaued even after 10⁵ itirations indicating that more optimizer steps might result in convergence. Moreover, the preliminary Ansatz used here is not tailored to the H ₂O molecule Hamiltonian. There are good reasons to beleived that an Ansatz constiting of the correct connectivity between qubits in accordance with terms of the H ₂ O Hamiltonian will lead to better results. More work in this direction is ongoing.

### Application to Bosonic Problems

The same reasoning that was done for fermions to build the QOCA method can be applied to bosonic and spin -

$$\frac{1}{2}$$

(qubit) problems. The differences are that the universal control Hamiltonians equivalent to equation 30 differ in both cases and so are the associated drive terms. The type of problems and how they are mapped to a quantum computer is also different. Here, we briefly state how one would address bosonic and

$$\text{spin-} \frac{1}{2}$$

problems using a QOCA-like method.

Bosons are described by the Lie algebra of bosonic ladder operators

$${\hat{b}}_{i}$$

and

$${\hat{b}}_{i}^{†}$$

which obey the commutation relations:

$$\left[{\hat{b}}_{i}^{†} , {\hat{b}}_{j}^{†}\right] = {δ}_{i j}$$

$$= \left[{\hat{b}}_{i} , {\hat{b}}_{j}\right] = 0.$$

A universal control Hamiltonian for bosonic systems is of the form

$${\hat{H}}_{b} \left(t\right) = \begin{matrix}{\sum }_{j} \left({α}_{j} \left(t\right) {\hat{b}}_{j} + {α}_{j}^{∗} \left(t\right) {\hat{b}}_{j}^{†}\right) + {\sum }_{i , j} {β}_{i j} \left(t\right) \left({\hat{b}}_{i}^{†} {\hat{b}}_{j} + {b}_{j}^{†} {b}_{i}\right) + \\ {\sum }_{i , j} {γ}_{i j} \left(t\right) {\hat{b}}_{i}^{†} {\hat{b}}_{j}^{†} {\hat{b}}_{i} {\hat{b}}_{j} + {\sum }_{i , j} {δ}_{i j} \left(t\right) \left({\hat{b}}_{i} {\hat{b}}_{j} + {\hat{b}}_{j}^{†} {\hat{b}}_{i}^{†}\right) ,\end{matrix}$$

where the α, β, γ and δ are controllable. Note that contrary to the case of fermions, every term here describes physical processes. This Hamiltonian, and the corresponding Lie algebra generated by {-iĤ_{b}}, can be sampled to constitute the symmetry-breaking terms {Ĥₖ} of the QOCA variational form (ref eq 10) applied to bosonic problems.

To closely relate to the discussion on fermions, we consider the Bose-Hubbard model as an example of bosonic problem

$${\hat{H}}_{B H M} = - t {\sum }_{\left〈i , j\right〉} {\hat{b}}_{i}^{†} {\hat{b}}_{j} + \frac{U}{2} {\sum }_{i} {\hat{n}}_{i} \left({\hat{n}}_{i} - 1\right) + μ {\sum }_{i} {\hat{n}}_{i} .$$

This Hamiltonian describes interacting bosons on a lattice. n̂ᵢ = b̂ᵢ^{†}b̂ᵢ is the number operator, t is the hopping amplitude, U is the interaction strength and µ is the chemical potential.

There are several ways to map bosonic modes to qubits which have varying ressource requirements in terms of number of qubits and allowed operations.

As an example, one could use the Single-Excitation-Subspace encoding in which we use nₘₐₓ qubits to encode the first nₘₐₓ energy level of a bosonic mode. Such a truncation is necessary as the Hilbert space associated with bosonic modes is infinite-dimensional. We map the state containing n excitation as

$$\left|\left(n\right〉 ↦\right| \left({0}_{0} … {0}_{n - 1} {1}_{n} {0}_{n + 1} … {0}_{{n}_{max}}\right〉 ,$$

and the associated ladder operators as

$${\hat{b}}_{k} ↦ {\sum }_{n = 0}^{{n}_{max} - 1} \sqrt{n + 1} {\hat{σ}}_{n}^{+} {\hat{σ}}_{n + 1}^{-} ,$$

$${\hat{b}}_{k}^{†} ↦ {\sum }_{n = 0}^{{n}_{max} - 1} \sqrt{n} {\hat{σ}}_{n + 1}^{-} {\hat{σ}}_{n}^{+} .$$

As for the Fermi-Hubbard model, the variational circuit could take the form of

$${\hat{U}}_{Q O C A} \left(θ , δ\right) = \prod {}_{d} \left({\prod }_{j} {e}^{i {θ}_{j , d} {\hat{H}}_{j}} {\prod }_{k} {e}^{i {δ}_{k , d} {\hat{H}}_{k}}\right) .$$

where Ĥ_{problem} is now the Bose-Hubbard model (equation 39). Because there are no linear terms in equation 39, potentially good drive Hamiltonians are of the form

$$\left({α}_{j} \left(t\right) {\hat{b}}_{j} + {α}_{j}^{∗} \left(t\right) {\hat{b}}_{j}^{†}\right)$$

as it was the case for the Fermi-Hubbard model. Other possible bosonic drive terms are presented in Table 1. All of these term are elements of the Lie algebra generated by the universal control Hamiltonian for bosonic systems presented above.

### Application to Qubit Problems

Qubits are described by the Lie algebra of Pauli matrices σ̂ₓ, σ̂_{y} and σ̂_{z} which satisfy the commutation and anti-commutation relations:

$$\left[{σ}_{a} , {σ}_{b}\right] = 2 i {ε}_{a b c} {σ}_{c} ,$$

$$\left\{{σ}_{a} , {σ}_{b}\right\} = 2 {δ}_{a b} I ,$$

where a, b, c ∈, x, y, z and ε_{abc} is the Levi-Civita symbol.

A theorem states that generic single-qubit control and any interaction between two qubits is sufficient for building any unitary matrices. A universal control Hamiltonian for qubits systems is therefore of the form

$${\hat{H}}_{q} \left(t\right) = {\sum }_{j} \left({α}_{{x}_{j}} \left(t\right) {\hat{σ}}_{x}^{j} + {α}_{{y}_{j}} \left(t\right) {\hat{σ}}_{y}^{j}\right) + {\sum }_{i , j} {β}_{i j} \left(t\right) {\hat{σ}}_{z}^{i} {\hat{σ}}_{z}^{j} ,$$

where

$${σ}_{a}^{i}$$

denotes σₐ, applied on qubit i. Again, this Hamiltonian, and the corresponding Lie algebra generated by {-iĤ_{q}}, can be sampled to constitute the symmetry-breaking terms {Ĥₖ} of the QOCA variational form applied to

$$\text{spin-} \frac{1}{2}$$

problems.

An example of a

$$\text{spin} \text{-} \frac{1}{2}$$

problem would be the Heisenberg XYZ chain with periodic boundary conditions defined as

$${\hat{H}}_{X Y Z} = - \frac{1}{2} {\sum }_{j = 1}^{N} \left({J}_{x} {\hat{σ}}_{x}^{j} {\hat{σ}}_{x}^{j + 1} + {J}_{y} {\hat{σ}}_{y}^{j} {\hat{σ}}_{y}^{j + 1} + {J}_{z} {\hat{σ}}_{z}^{j} {\hat{σ}}_{z}^{j + 1} + h {\hat{σ}}_{z}^{j}\right) ,$$

where we associate the indices N + 1 = 1. The Jₐ are coupling constants and h is the energy of every identical spins.

As opposed to fermions and bosons,

$$\text{spin} \text{-} \frac{1}{2}$$

problems are trivially mapped to qubits. Indeed, they share the same Lie algebra su(2).

Again, as for the last two examples, the variational circuit could take the form of (eq 12) where Ĥ_{problem} is now the Heisenberg XYZ chain with periodic boundary conditions defined as above. The drive terms could be of the form ξ_{ab}(t)σ̂ₐσ̂_{b} with a ≠ b, since these terms do not commute with Ĥ_{XYZ}, or a generic single-site drive of the form

$${α}_{{x}_{j}} \left(t\right) {\hat{σ}}_{x}^{j} + {α}_{{y}_{j}} \left(t\right) {\hat{σ}}_{y}^{j} .$$

### Further Generalization

The last two sections illustrate how one would tackle quantum mechanical problems of different nature using a QOCA-like method. However, it is possible the apply the same technique to a broader class of problems e.g. a class that would include classical Hamiltonians. The main steps of how one could proceed to build the QOCA variational form may be broken down in the following way:
1. Formulate the problem in terms of a Hamiltonian Ĥ_{problem} which the ground state and its expectation value under Ĥ_{problem} constitute the solution to find.
2. Map Ĥ_{problem} to a qubit Hamiltonian. Note that the choice of mapping may depend on the problem.
3. Find a universal control Hamiltonian of the same nature of Ĥ_{problem} i.e. bosonic, fermionic, classical, etc.
4. Select drive terms {Ĥₖ} that do not commute with Ĥ_{problem} from the Lie algebra generated by the control Hamiltonian.
5. Build the QOCA variational form using Ĥ_{problem} and the selected drive terms {Ĥₖ}.

As can be understood in view of the above, the examples described above and illustrated are intended to be exemplary only. It will be further understood that, for instance, it is possible to specifically dictate parameters to be used in a parameterized quantum circuit, rather than have these parameters calculated iteratively using classical processing. Moreover, while typically a same circuit structure is used for multiple quantum computation iterations, some meta-algorithms such as adapt-vqe can allow changing the circuit structure itself during the processing. This would typically be done following a plurality of quantum processing iterations, for example. Various initialization schemes can be used in different embodiments. For instance, the initialization routine of the quantum computation can include a simple preparation containing single qubit gates such as H^{⊗n}|0〉^{⊗n} , the Hartree-Fock state of quantum chemistry, or a more complex initialization routine containing one or more single-qubit gates and one or more multi-qubit gates. A suitable choice can be selected and tested as a function of the details of a specific embodiment. The scope is indicated by the appended claims.

What is claimed is:

1. A method comprising performing a quantum computation including, in sequence, initializing a plurality of qubits of a quantum processor, applying a sequence of quantum logic gates onto the qubits in accordance with a quantum circuit which is based on a problem Hamiltonian Ĥ_{problem} and at least one additional Hamiltonian Ĥₖ which does not commute with Ĥ_{problem}, and measuring the expectation value of Ĥ_{problem} in the final state of the qubits.

2. The method of claim 1 wherein the quantum circuit is a parameterized quantum circuit having a structure and a plurality of variable parameters, the quantum computation is an iteration of a Variable Quantum Algorithm, further comprising, subsequently to said performing the quantum computation iteration, communicating the expectation value of Ĥ_{problem} to a classical computer, the classical computer proposing a set of values of the parameters of the quantum circuit on the basis of the expectation value, and performing a subsequent quantum computation iteration using the optimized parameter values in the quantum circuit.

3. The method of claim 2 wherein the steps of performing a quantum computation iteration and proposing a set of values of the parameters are repeated a plurality of times, until the classical computer determines that convergence has been reached based on the measured expectation value of the previous iteration and the measured expectation value of at least one earlier iteration.

4. The method of claim 1 wherein Ĥ_{problem} describes a quantum mechanical system.

5. The method of claim 1 wherein the qubits are defined on a computational basis, and wherein Ĥ_{problem} is not diagonal in the computational basis.

6. The method of claim 1 wherein the parameterized quantum circuit includes parameters associated with Ĥ_{problem} and parameters associated with the at least one additional Hamiltonian Ĥₖ.

7. The method of claim 1 wherein the initial state is in the form of [symbol] .

8. The method of claim 1 wherein said at least one additional Hamiltonian Ĥₖ is in the form of one or more elements of the Lie algebra generated by {-iĤ_{ƒ}}, where
$$\begin{matrix}{\hat{H}}_{f} \left(t\right) = {\sum }_{j} \left({a}_{j} \left(t\right) {\hat{a}}_{j} + {a}_{j}^{*} \left(t\right) {\hat{a}}_{j}^{†}\right) + {\sum }_{i , j} {β}_{i j} \left(t\right) \left({\hat{a}}_{i}^{†} {\hat{a}}_{j} + {\hat{a}}_{j}^{†} {\hat{a}}_{i}\right) \\ + {\sum }_{i , j} {γ}_{i j} \left(t\right) {\hat{a}}_{i}^{†} {\hat{a}}_{i} {\hat{a}}_{j}^{†} {\hat{a}}_{j} .\end{matrix}$$
.

9. The method of claim 8, wherein the at least one additional Hamiltonian Hk is in the form of [symbol] .

10. The method of claim 1 wherein the parameterized quantum circuit is in the form of the Ansatz
$${\hat{U}}_{\text{QOCA}} \left(\text{θ} , \text{δ}\right) = {\prod }_{d} \left({\prod }_{j} {e}^{i θ j , d \hat{H} j} {\prod }_{k} {e}^{i {δ}_{k , d} {\hat{H}}_{k}}\right) . ,$$
where {Ĥₖ} is a set of drive Hamiltonians that does not commute with a problem Hamiltonian Ĥ_{problem} [symbol] are variational parameters associated with ̂̂̂Ĥ_{problem}, and where δ={δ_{k,d}} are variational parameters associated with {Ĥₖ}.

11. The method of claim 10 wherein the set of drive hamiltonians {Ĥₖ} is in the form of [symbol] .

12. The method of claim 5 wherein said at least one additional Hamiltonian Ĥₖ is in the form of one or more elements of the Lie algebra generated by {-iĤ_{ƒ}}, where
$$\begin{matrix}{\hat{H}}_{q} \left(t\right) = {\sum }_{j} \left({α}_{{x}_{j}} \left(t\right) {\hat{σ}}_{x}^{j} + {α}_{{y}_{j}} \left(t\right) {\hat{σ}}_{y}^{j}\right) + \\ {\sum }_{i , j} {β}_{i j} \left(t\right) {\hat{σ}}_{z}^{i} {\hat{σ}}_{z}^{j} .\end{matrix}$$
.

13. The method of claim 5 wherein said at least one additional Hamiltonian Ĥₖ is in the form of one or more elements of the Lie algebra generated by {-iĤ_{ƒ}}, where
$$\begin{matrix}{\hat{H}}_{b} \left(t\right) = {\sum }_{j} \left({α}_{j} \left(t\right) {\hat{b}}_{j} + {α}_{j}^{*} \left(t\right) {\hat{b}}_{j}^{†}\right) + \\ {\sum }_{i , j} {β}_{i j} \left(t\right) \left({\hat{b}}_{i}^{†} {\hat{b}}_{j} + {\hat{b}}_{j}^{†} {\hat{b}}_{i}\right) + \\ {\sum }_{i , j} {γ}_{i j} \left(t\right) {\hat{b}}_{i}^{†} {\hat{b}}_{j}^{†} {\hat{b}}_{i} {\hat{b}}_{j} + {\sum }_{i , j} {δ}_{i j} \left(t\right) \left({\hat{b}}_{i} {b}_{j} + {\hat{b}}_{j}^{†} {\hat{b}}_{i}^{†}\right) ,\end{matrix}$$
.

14. A quantum circuit in the form of computer readable instructions stored in a non-transitory memory which, when executed by a classical processor is operable to drive the application of quantum gates onto qubits of a quantum processor, wherein the quantum circuit is based on a problem Hamiltonian Ĥ_{problem} and at least one additional Hamiltonian Ĥₖ which does not commute with Ĥ_{problem}.

15. The quantum circuit of claim 14 wherein Ĥ_{problem} describes a quantum mechanical system.

16. The quantum circuit of claim 14 wherein the qubits are defined on a computational basis, and wherein Ĥ_{problem} is not diagonal in the computational basis.

17. The quantum circuit of claim 14 wherein the parameterized quantum circuit includes parameters associated with Ĥ_{problem} and parameters associated with the at least one additional Hamiltonian Ĥₖ.

18. The quantum circuit of claim 14 wherein said at least one additional Hamiltonian Ĥₖ is in the form of one or more elements of the Lie algebra generated by {-iĤ_{ƒ}}, where
$$\begin{matrix}{\hat{H}}_{f} \left(t\right) = {\sum }_{j} \begin{matrix}\left({α}_{j} \left(t\right) {\hat{a}}_{j} + {α}_{j}^{*} \left(t\right) {\hat{a}}_{j}^{†}\right) 3 \\ + {\sum }_{i , j} {β}_{i j} \left(t\right) \left({\hat{a}}_{i}^{†} {\hat{a}}_{j} + {\hat{a}}_{j}^{†} {\hat{a}}_{j} + {\hat{a}}_{j}^{†} {\hat{a}}_{i}\right)\end{matrix} \\ + {\sum }_{i , j} {γ}_{i j} \left(t\right) {\hat{a}}_{i}^{†} {\hat{a}}_{i} {\hat{a}}_{j}^{†} {\hat{a}}_{j}\end{matrix}$$
.

19. The quantum circuit of claim 18, wherein the at least one additional Hamiltonian Hk is in the form of [symbol] .

20. The quantum circuit of claim 14 provided in the form of the Ansatz
$${\hat{U}}_{\text{QOCA}} \left(θ , δ\right) = {\prod }_{d} \left({\prod }_{j} {e}^{i {θ}_{j , d} {\hat{H}}_{j}} {\prod }_{k} {e}^{i {δ}_{k , d} {\hat{H}}_{k}}\right) . ,$$
where {Ĥₖ} is a set of drive Hamiltonians that does not commute with a problem Hamiltonian [symbol] , where θ={θⱼ,d} are variational parameters associated with Ĥ_{problem}, and where δ = {δk,d} are variational parameters associated with {Ĥₖ}.

21. The quantum circuit of claim 20 wherein the set of drive hamiltonians {Ĥₖ} is in the form of [symbol] .

22. The quantum circuit of claim 16 wherein said at least one additional Hamiltonian Ĥₖ is in the form of one or more elements of the Lie algebra generated by {-iĤ_{ƒ}}, where
$${\hat{H}}_{q} \left(t\right) = {\sum }_{j} \left({α}_{{x}_{j}} \left(t\right) {\hat{σ}}_{x}^{j} + {α}_{{y}_{j}} \left(t\right) {\hat{σ}}_{y}^{j}\right) + {\sum }_{i , j} {β}_{i j} \left(t\right) {\hat{σ}}_{z}^{i} {\hat{σ}}_{z}^{j} .$$
.

23. The quantum circuit of claim 16 wherein said at least one additional Hamiltonian Ĥₖ is in the form of one or more elements of the Lie algebra generated by {-iĤ_{ƒ}}, where
$${\hat{H}}_{b} \left(t\right) = \begin{matrix}{\sum }_{j} \begin{matrix}\left({α}_{j} \left(t\right) {\hat{b}}_{j} + {α}_{j}^{*} \left(t\right) {\hat{b}}_{j}^{†}\right) + \\ {\sum }_{i , j} {β}_{i j} \left(t\right) \left({\hat{b}}_{i}^{†} {\hat{b}}_{j} + {\hat{b}}_{j}^{†} {\hat{b}}_{i}\right) +\end{matrix} \\ \begin{matrix}{\sum }_{i , j} {γ}_{i j} \left(t\right) {\hat{b}}_{i}^{†} {\hat{b}}_{j}^{†} {\hat{b}}_{i} {\hat{b}}_{j} + \\ {\sum }_{i , j} {δ}_{i j} \left(t\right) \left({\hat{b}}_{i} {\hat{b}}_{j} + {\hat{b}}_{j}^{†} {\hat{b}}_{i}^{†}\right) ,\end{matrix}\end{matrix}$$
.
